(19) United States
(12) Patent Application Publication
(10) Pub. No.: US 2006/0023227 A1
(43) Pub. Date: Feb. 2, 2006

(54) Method for positioning a measuring device emitting and receiving optical radiation for measuring wear in the lining of a container

(76) Inventor: Hannu Ensio Jokinen, Oulunsalo (FI)

Correspondence Address: Michael J Herman;Minerals Technologies Inc, One Highland Avenue, Bethlehem, PA, 18017, US

(21) Appl. No.: 10/537,849

(22) PCT Filed: Nov. 5, 2003
(86) PCT No.: PCT/EP03/12348

§ 371 Date: Jun. 8, 2005

(30) Foreign Application Priority Data
Dec. 9, 2002 (DE) 10257422.7

(51) Int. Cl. G01B 11/24

(52) U.S. Cl. 356/601

(57) ABSTRACT

The present invention relates to a method for positioning a method for positioning a measuring device which emits and receives optical radiation to measure wear in the lining of a container, said method involving fixing coordinate systems for the measuring device and the container by combining that coordinate systems, and individually determining the positions of a plurality of specific fixing marks in the coordinate system of the measuring device, wherein each of said fixing marks is substantially regular in shape, wherein the position of the fixing marks are determined by: (a) deflecting an optical radiation beam across a first fixing mark in first and second intersecting directions and determining the position of the center and least two linear edges thereof and creating a first temporary coordinate system based on the position of the center and the directions of the at least two edges, (b) searching, based on the first temporary coordinate system, at least two further fixing marks and determining the position of the centers thereof, (c) defining, based on the center positions of said fixing marks, the coordinate system of the container.

### BACKGROUND OF THE INVENTION

The present invention relates to a method for positioning a measuring device emitting and receiving optical radiation for measuring wear in the lining of a container, said method comprising fixing the coordinate systems set for the measuring device and the container, said fixing comprising mathematically combining the coordinate systems of the measuring devices and container by measuring the position of specific fixing points in the coordinate system of the measuring device.

It is extremely significant to measure wear in the lining of converters of ladles used in steel making. This renders it possible to optimize the service life of the container and to prevent excessive wear in the lining from causing risks pertaining to production or industrial safety. Wear linings of converters must be renewed relatively often, as their life time varies from a week or two normally to no more than a few months, depending on what is melted in the converter, on the material of which the lining is made, and naturally on the number of meltings for which the converter is used. Generally speaking, a converter can last for about 100 to 5000 meltings.

The wear in a lining is measured by a method based on measuring the propagation time or phase difference of a laser beam: the laser beam is directed to the lining on the inner surface of a converter, from which it is reflected back to the measuring device. In the method based on measuring the propagation time, the distance between the measuring device and each measured point on the lining to be measured in the coordinate system of the measuring device can be calculated on the basis of the time difference between the emitting time and the return time of the laser beam. The measured points define the wear profile of the lining, which may be output for instance to a display terminal, by which the wear profile measured from a converter in use can be compared graphically and numerically with the profile that was measured of the inner surface of the same container during the modeling step before the container was actually brought into use, i.e. before the first melting.

To measure wear in the lining of three-dimensional objects, such as converters, ladles and other containers used in the steel industry, by non-contacting methods, such as laser measurement, it is required that the measuring device and the object to be measured be represented in the same coordinate system. Combining the coordinate systems of the measuring device and the object to be measured is called fixing. In other words, the measuring device is positioned in relation to the object. For the fixing it is necessary to use at least three fixing points to each of which the laser beam of the measuring device is directed in turn, and from which the coordinates of each fixing point in the coordinate system of the measuring device are measured. Even if the measuring device has a fixed or semi-fixed position in the vicinity of the container, it is necessary, in any case, to perform the fixing separately for each lining measurement; thus it is ensured that a change in the ambient conditions, and other factors do not cause any errors. It is also necessary to perform fixing each time all over again in order to estimate whether the fixing has succeeded.

In the so-called direct procedure normally used for positioning, or fixing, stationary fixing marks are mounted on the object to be measured such as a container—more specifically, in the vicinity of the container opening. By means of the fixing marks, the coordinate systems of the object and the measuring device can be mathematically combined. In the direct procedure, the object to be measured and the measuring device can be included in the same coordinate system by measuring at a time both the fixing marks and the points to be actually measured.

In a special case where the object to be measured is supported by a pivoted axle, it is possible to use indirect angle measurement fixing, in which the fixing marks are located outside the container. An angle measuring device can be mounted, for example, on the pivoted axle of the container or elsewhere in the container if a so-called inclinometer is employed. At present, fixing by means of angle measurement is and indirect method which is used if it is impossible to provide the object to be measured with necessary fixing marks which are clearly visible and the position of which is even otherwise detectable. Angle measurement fixing has been performed using fixing marks in structures outside the object to be measured and an angle value obtained from the angle measurement device; this has allowed the coordinate systems to be mathematically combined. The fixing marks have been attached to the frame structures of a factory wall, for example, in proximity to the converter. When angle measurement is used in the known methods, the angle measurement device informs the measuring device of the position of the object, or container, in relation to the known environment.

In both direct and indirect angle measurement fixing, the fixing marks are, for example, small steel plates, to which the laser beam emitted by the measuring device is manually directed, for instance by means of binoculars or some other instrument. In these known methods, the aim is to direct the laser beam manually to the center of the fixing mark, to gather a fixing point in order that the fixing could succeed. The operators of the measuring device are thus required to perform several operations before all fixing points have been measured. The drawback of these known methods is that it is difficult to automate the fixing operation; in addition, when the fixing is performed by a human being, there is a risk of errors in both the estimate of the center of the fixing mark and the actual directing step.

From U.S. Pat. No. 5,570,185 it is known to use fixing or calibration marks for fixing the coordinate systems that are of a substantially regular shape, where the position of each fixing mark in the coordinate system of the measuring device is measured by deflecting optical radiation in two intersecting directions across the fixing mark, by measuring the optical radiation reflected from the fixing mark, by determining, on the basis of the optical radiation reflected to the measuring device, at least two intersections between the fixing mark and the optical radiation emitted in both deflection directions, and by calculating on the basis of these at least four intersections a directing point, to which the optical radiation emitted by the measuring device is directed for determining the coordinates of the fixing mark in the coordinate system of the measuring device.

This method is based on the idea of replacing a conventional fixing mark with a fixing mark of a regular shape, preferably annular; the center of the fixing mark is determined by two laser beam deflections with different directions, and the necessary calculations; a laser beam is directed to this center, whereby the accurate coordinates of the fixing point in the coordination system of the measuring device are measured automatically.

However, there is still the need for further improving the existing methods to further accelerate them and to render them more reliable.

### SUMMARY OF THE INVENTION

This is achieved with the present method for positioning a measuring device which emits and receives optical radiation to measure wear in the lining of a container, said method involving fixing coordinate systems for the measuring device and the container by combining that coordinate systems, and individually determining the positions of a plurality of specific fixing marks in the coordinate system of the measuring device, wherein each of said fixing marks is substantially regular in shape, wherein the position of the fixing marks are determined by:
(a) deflecting an optical radiation beam across a first fixing mark in first and second intersecting directions and determining the position of the center and least two linear edges thereof and creating a first temporary coordinate system based on the position of the center and the directions of the at least two edges,
(b) searching, based on the first temporary coordinate system, at least two further fixing marks and determining the position of the centers thereof, and
(c) defining, based on the center positions of said fixing marks, the coordinate system of the container.

### BRIEF DESCRIPTION OF THE DRAWINGS

In the following, the invention will be described in greater detail with reference to the accompanying drawings, in which:

FIG. 1 illustrates the first preparation step making the system ready for direct manual positioning and measurement,

FIG. 2 illustrates the second preparation step making the system ready for indirect manual positioning and measurement, and

FIG. 3 illustrates the third preparation step making the system ready for automatic positioning and measurement.

### DETAILED DESCRIPTION OF THE PREFERRED EMBODIMENTS

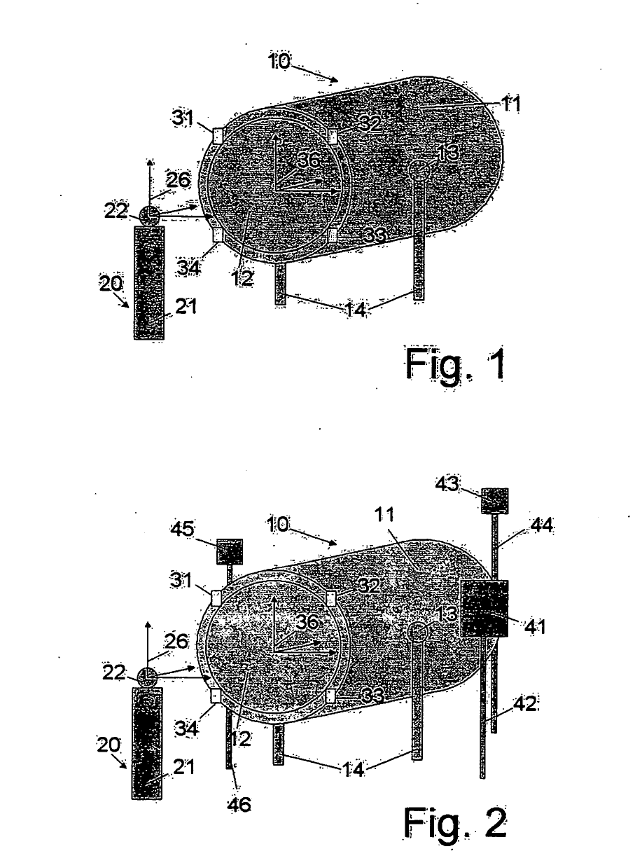

FIG. 1 illustrates the first preparation step making the system ready for direct manual positioning and measurement. FIG. 1 shows the object to be measured, i.e. a container 10 comprising an outer surface 11 and an inner surface 12 comprising a lining (not illustrated), the wear of which is to be measured. The container 10, such as a converter is hung on its pivoted axle 13, which is supported by an axle support 14. The actual measuring device 20 comprises a laser transceiver 22 and its support 21. FIG. 1 also shows the coordinate system 26 of the measuring device having x-, y- and z-axes. The coordinate system 36 of the object to be measured, i.e. the container 10, also correspondingly comprises x-, y- and z-axes. Mathematcally, the coordinate system 36 of the object to be measured, i.e. the container 10 such as a converter is in the center of its opening, and the z-axis of the coordinate system 36 extends along the longitudinal axis of the container 10. In the coordinate system 36, the x-axis is horizontal and the y-axis is vertical.

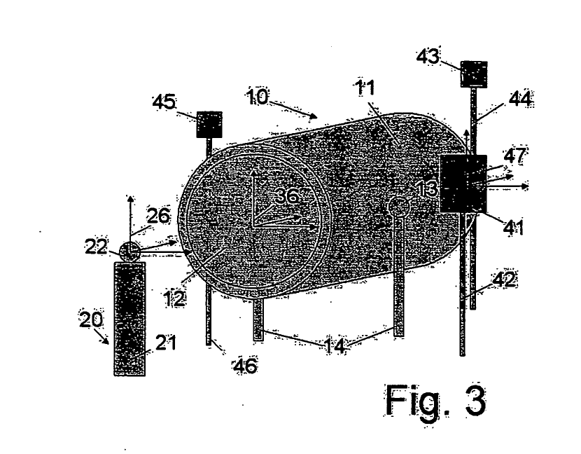

Preferably, the assembly also includes an angle measuring device (not shown), which measures the inclination of the container and is most preferably disposed on the pivoted axle 13 of the container 10. Angle measurement data can be transmitted to the measuring device via cable or a radio path. The angle measuring device is needed if the container 10 is rotated between the fixing measurement and the measurement of the lining; it is also needed when the fixing marks (41, 43, 45, FIGS. 2 and 3) are positioned outside the container, i.e. in indirect fixing measurement.

The coordinate systems 26, 36 of the measuring device 20 and the container 10 are conventionally mathematically combined by measuring the positions of specific points of fixing marks 31 to 34 in the coordinate system 16 of the measuring device 20. The fixing marks 31 to 34 are preferably of a regular shape. The centers of the fixing marks 31 to 34 are in fact the fixing points, the coordinates of which are being measured. The measurement is described in detail in U.S. Pat. No. 5,570,185, which is fully incorporated herein by reference.

After performing the measurement, the system is ready for direct manual positioning and measurement. In the practice of the present invention this fixing measurement has to be performed only once in the preparation of the system. All further measurements used for fixing the system are carried out with respect to external fixing marks (41, 43, 45, FIGS. 2, 3).

Turning now to FIGS. 2 and 3, additionally three external fixing marks 41, 43, 45 are assembled on fixing mark supports 42, 44, 46, preferably outside the vessel in a stable environment. The fixing marks 41, 43, 45 are attached, for example, to the factory wall or elsewhere in the vicinity of the container 10. First fixing mark 41 is preferably of rectangular shape and most preferably larger in size than the at least two further fixing marks 43, 45. The at least two further fixing marks 43, 45 may be of elliptical shape or a mark anyway located on the target surface. However, preferably they are also of rectangular shape.

In practice of the present invention, the center point and plane and edge directions of first fixing mark 41 are measured by deflecting an optical radiation beam across said first fixing mark 41 in first and second intersecting directions. Based on this information a first temporary coordinate system 47 (FIG. 3) is created.

On the basis of the first temporary coordinate system, at least two further fixing marks 43, 45 are searched and the position thereof is determined, preferably by calculating the center of said fixing marks 43, 45 from the intersections thereof, most preferably by one of distance measuring and reflection intensity measuring. To facilitate measurement, fixing marks 41, 43, 45 preferably comprise a retro-reflective surface.

Finally, based on the center positions of said fixing marks 41, 43, 45, and the angle value obtained from angle measurement, the coordinate system 36 of the container 10 is determined. These data allow the coordinate systems 26 and 36 to be combined.

Generally, the method can be used for combining the coordinate system of an object to be measured and the measuring device. The object to be measured can thus be other than a container. The method does not have to be applied to measuring wear in a lining or another coating, although it is particularly useful for it. The method may also be applied for other measurements in which it is necessary to combine the coordinate systems of the object to be measured and the measuring device.

Although the invention has been described above with reference to the examples according to the accompanying drawings, it will be obvious that the invention is not restricted thereto but can be modified in many ways within the scope of the invented concept disclosed in the appended claims. For instance, the method according to the present invention is not limited to indirect measurement of the coordinate system 36 of the container. It can also be employed in direct measurement, where the fixing marks are directly attached to the container. In this case, an optical reflectivity of the fixing marks is preferably significantly different from that of an area of the container surrounding the fixing marks. However, it not necessary that the target marks are made of a separate piece of material. It is also possible that the fixing marks be of a natural shape or form or a mark on the target surface.

What is claimed:

1.) A method for position a measuring device (20) which emits and receives optical radiation to measure wear in the lining of a container (10), said method involving fixing coordinate systems (26, 36) for the measuring device (20) and the container (10) by combining that coordinate systems, and individually determining the positions of a plurality of specific fixing marks (41, 43, 45) in the coordinate system (26) of the measuring device (20), wherein each of said fixing marks (41,43, 45) is substantially regular in shape, wherein the position of the fixing marks (41,43,45) are determined by:
(a) deflecting and optical radiation beam across a first fixing mark (41) in first and second intersecting directions and determining the position of the center and least two linear edges thereof and creating a first temporary coordinate system (47) based on the position of the center and the directions of the at least two edges thereof,
(b) searching, based on the first temporary coordinate system (47), at least two further fixing marks (43, 45) and determining the position of the centers thereof,
(c) defining, based on the center positions of said fixing marks (41,43, 45) the coordinate system (36) of the container (10).

2.) The method of claim 1, wherein the first fixing mark (41) is substantially rectangular in shape.

3.) The method according to claims 1 or 2 wherein the first fixing mark (41) is larger in size than the at least two further fixing marks (43, 45).

4.) The method of claim 1, wherein the center of the fixing marks (41, 43, 45) is calculated from the intersections thereof.

5.) The method according to claim 4, wherein the intersections are detected by one of distance measuring and reflection intensity measuring.

6.) The method according to claim 5, wherein the fixing marks (41,43, 45) comprise a retro-reflective surface.
